(19) United States
(12) Patent Application Publication
(10) Pub. No.: US 2012/0030383 A1
(43) Pub. Date: Feb. 2, 2012

(54) DIGITAL MEDIA PROVIDING DEVICE WITH EXPANDABLE TRANSCODING CAPABILITY AND METHOD THEREOF

(76) Inventor: Yan-Zhang HUANG, Xinzhuang City (TW)

(21) Appl. No.: 12/902,728

(22) Filed: Oct. 12, 2010

(30) Foreign Application Priority Data
Jul. 30, 2010 (TW) 099125496

(51) Int. Cl. G06F 13/10

(52) U.S. Cl. 710/30

(57) ABSTRACT

A digital media providing device comprises a first interface for coupling to a first storage device storing a first media data of a first encoding format, a second interface for coupling to a second storage device storing a program code, and a third interface for coupling to a transcoding device. The transcoding device executes the program code when the third interface is coupled to the transcoding device, converts the first media data in to a second media data of a second encoding format, and transmits the second media data to a digital content receiving device.

### CROSS-REFERENCE TO RELATED APPLICATIONS

This application claims the benefit of priority to Taiwanese Patent Application No. 099125496, filed on Jul. 30, 2010, the entirety of which is incorporated herein by reference for all purposes.

### BACKGROUND

The present disclosure generally relates to a digital media providing device, and more particularly, to a digital media providing device with expandable transcoding capability.

As the prevalence of digitized media content, people are used to enjoy digital media content on different electronic devices. For example, photographs, videos, and music are often played on televisions, computers, mobile phones, and a variety of media players. Conventionally, the media content is stored in separate devices and played. The progress in network technology has made it possible for electronic devices to access the media content stored in file serves or digital media servers. Different media players, however, might only support certain media formats, e.g., file formats, image/video sizes, encoding formats, encoding rates, and other encoding parameters. The media content stored in the servers often needs to be transcoded, i.e., converted into appropriate media formats, before providing to the media players. It is not practical for a server to have the capability of converting the media content into any media formats. Besides, there will be always newer media formats developed and not supported by the server. A serve with expandable transcoding capability is, therefore, needed in this situation.

### SUMMARY

In view of the foregoing, it can be appreciated that a substantial need exists for devices that can mitigate the problems mentioned above.

An exemplary embodiment of a digital media providing device comprises a first interface for coupling to a first storage device storing a first media data of a first encoding format; a second interface for coupling to a second storage device storing a program code; and a third interface for coupling to a transcoding device; wherein the trans-coding device executes the program code when the third interface is coupled to the transcoding device, converts the first media data in to a second media data of a second encoding format, and transmits the second media data to a digital content receiving device.

Another exemplary embodiment of a digital media providing device, comprises a first interface for coupling to a first storage device storing a first media data of a first encoding format; a second interface for coupling to a second storage device storing a program code; and a third interface for coupling to a transcoding device; wherein the transcoding device executes the program code when the third interface is coupled to the transcoding device and converts the first media data in to a second media data of a second encoding format, the third interface receives the second media data from the transcoding devices, and the digital media providing device is coupled to a digital media receiving device through the third interface and/or a fourth interface for transmitting the second media data.

An exemplary embodiment of a computer program product capable of enabling a computer to perform a transcoding operation, the transcoding operation comprises receiving a first media data of a first encoding format from a digital media providing device; and converting the first media data into a second media data of a second encoding format.

It is to be understood that both the foregoing general description and the following detailed description are exemplary and explanatory only and are not restrictive of the invention, as claimed.

### BRIEF DESCRIPTION OF THE DRAWINGS

FIG. 1 shows a simplified functional block diagram of an example digital media system;

FIG. 2 shows a simplified flowchart of an example transcoding method; and

FIG. 3 show a simplified flowchart of another example transcoding method, all arranged in accordance with at least some embodiments of the present disclosure described herein.

### DETAILED DESCRIPTION

Reference will now be made in detail to exemplary embodiments of the disclosure, which are illustrated in the accompanying drawings. The same reference numbers may be used throughout the drawings to refer to the same or like parts or operations.

Certain terms are used throughout the description and following claims to refer to particular components. As one skilled in the art will appreciate, a component may be referred to as different names. This disclosure does not intend to distinguish between components that differ in name but not in function. In the following description and in the claims, the terms “include” and “comprise” are used in an open-ended fashion, and thus should be interpreted to mean “include, but not limited to . . . .” The phrase “coupled to” is intended to compass any indirect or direct connection. Accordingly, if this disclosure mentioned that a first device is coupled to a second device, it means that the first device may be directly or indirectly connected to the second device through an electrical connection, wireless communications, optical communications, or other signal connections with/without other intermediate device or connection means.

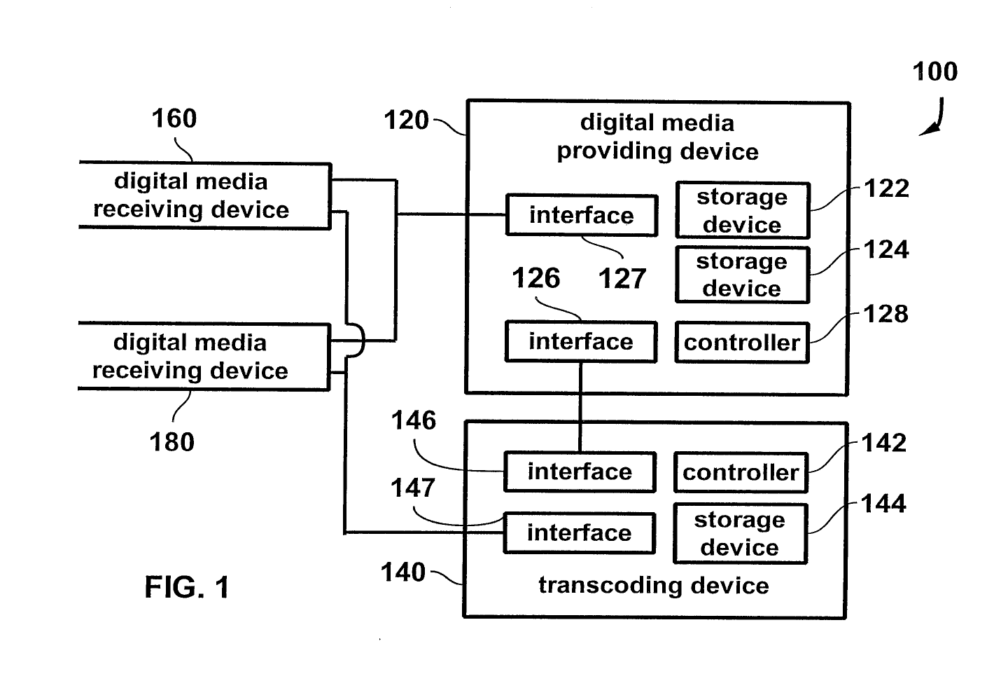

FIG. 1 shows a simplified functional block diagram of an example digital media system 100. The digital media system 100 comprises a digital media providing device 120, a transcoding device 140, and digital media receiving devices 160 and 180. The number of the devices is illustrative and not intends to be limited.

The digital media providing device 120 comprises storage devices 122 and 124, interfaces 126 and 127, and a controller 128. The storage device 122 is used to store media data and the storage 124 is used to store a program code. The storage device 122 and 124 can be coupled to other components of the digital media providing device 120 with any suitable internal and/or external interface(s). The program code in the storage device 124 can be source codes, assembly codes, executable codes or other suitable form of a programming language. The digital media providing device 120 is coupled to the transcoding device 140 through the interface 126 and to the digital media receiving devices 160 and 180 through the interface 127. Through the interface 127, the controller 128 receives the media data transmission requests from the digital media receiving devices 160 and 180, and transmits the media data stored in the storage device 122 to the digital media receiving device 160 and 180. The controller can also transmit the media data in the storage device 122 and the program code in the storage 124 to the transcoding device 140 through the interface 126. The transcoding device 140 executes the program code and converts the media data received from the controller 128 into a suitable encoding format. The conversion of the encoding format(s) of the media data is also known as transcoding.

The storage devices 122 and 124 can be implemented with hard drives, optical drives, flash memory, or other suitable physical or chemical storage devices. Besides, the storage devices 122 and 124 can be implemented with a single storage device or different storage devices, and coupled to other component(s) of the digital media providing device 120 through the same or different interfaces. The interfaces 126, 127, and the interfaces of the storage devices 122 and 124 can be implemented with Universal Serial Bus, IEEE1394, PC card, Serial or Parallel Advanced Technology Attachment, Peripheral Component Interconnect, PCI Express, wired networks, wireless networks, mobile networks, other suitable buses, protocols, and/or network technologies. Moreover, the four interfaces can be realized with multiple interfaces of different technologies, multiple interfaces of the same technology, and/or the same interface. The controller 128 can be implemented with one or more integrated circuits, processors, controller, other suitable circuits, hardware, or a combination of hardware and software.

The transcoding device 140 can be realized with a general purpose computer, a custom-designed hardware, or a combination of hardware and software. The transcoding device 140 comprises a controller 142, a storage device 144, and interfaces 146 and 147. The controller 142 can be implemented with one or more integrated circuits, processors, controller, other suitable circuits, hardware, or a combination of hardware and software. The storage device 144 can be implemented with one or more above-mentioned physical or chemical storage devices. The interface 146 is coupled to the digital media providing device 120 and the interface 147 is coupled to the digital media receiving device 160 and 180. The interfaces 146 and 147 can be realized with multiple interfaces of different technologies, multiple interfaces of the same technology, and/or the same interface. The transcoding device 140 can convert the media data received from the digital media providing device 120 into the suitable media format(s), e.g., the file format, the image/video size, the encoding format, the encoding rate, and other encoding parameters. The encoding related parameters are called the encoding format in this disclosure for conciseness. The digital media receiving devices 160 and 180 can be any electronic devices, e.g., computers, televisions, media players, handheld devices, mobile phones, other servers, digital media providing devices, digital media controllers, etc. The digital media receiving devices 160 and 180 can request the digital media providing device 120 to transmit the media data of the specific encoding format. In another example embodiment, the digital media receiving devices 160 and 180 have the capability of playing the media data.

In yet another example embodiment, the digital media providing device 120 can provide the media data of a first encoding format. The digital media receiving device 160 can play the media data of the first encoding format and the digital media receiving device 180 can play the media data of a second encoding format. When the digital media receiving device 160 requests the digital media providing device 120 to transmit the media data of the first encoding format, the digital media providing device 120 can provide the suitable media data to the digital media receiving device 160. When the digital media receiving device 180 requests the digital media providing device 120 to transmit the media data of the second encoding format, the digital media providing device 120 does not have the media data of the second encoding format. The digital media providing device 120, therefore, transmits the media data in the storage device 122 and the program code in the storage device 124 to the transcoding device 140. The transcoding device 140 receives and executes the program code to convert the received media data into the second encoding format. The converted media data of the second encoding format is sent to the digital media providing device 120 through the interface 146, and the digital media providing device 120 can provides the media data of the second encoding format to the digital media receiving device 180. In still another example embodiment, the digital media providing device 120 has the capability of converting the media data into a third encoding format. When the digital media receiving device 180 request the digital media providing device 120 to transmit the media data of the third encoding format, the digital media providing device 120 can convert the media data in to the third encoding format by itself and transmit the converted media data to the digital media receiving device 180.

In further another example embodiment, the digital media providing device 120 provides the information of the digital media receiving device 180, e.g., network address, to the transcoding device 140. The transcoding device 140 can, therefore, transmits the converted media data of the second encoding format to the digital media receiving device 180.

When the program code is an executable code, the digital media providing device 120 can transmit the executable code to the transcoding device 140 directly. The transcoding device 140 can execute the executable code and perform the transcoding operation. The program code can also be stored as source codes, assembly codes, etc. The digital media providing device 12 can compile or assemble the program code according to the structure of the transcoding device 140, and generate suitable executable code for the transcoding device 140. The transcoding device 140 receives and executes the generated executable code and performs the transcoding operation.

In yet still another example embodiment, the program code can be automatically executed by the transcoding device 140 to perform the transcoding operation requested by the digital media providing device 120 when the transcoding device 140 is coupled to the digital media providing device 120. For example, the transcoding device 140 is implemented with a computer and the digital media providing device 120 can emulate a mass storage class device, e.g., CD-ROM. When the digital media providing device 120 is coupled to the transcoding device 140, i.e., the computer, through USB, SATA, IEEE1395, or other interfaces, the transcoding device 140 can recognize the digital media providing device 120 as a CD-ROM or other mass storage class device, and automatically executes the program code on the digital media providing device 120 to perform the transcoding operation. The transcoding device 140 can also be implemented with a specifically designed hardware with standard or custom-designed protocols to perform the transcoding operation upon the request of the digital media providing device 120.

The program code can reside or be preloaded in the transcoding device 140 and therefore can detect whether the digital media providing device 120 has been coupled to the transcoding device 140. When coupling to the digital media providing device 120, the transcoding device 140 then performs the transcoding operation upon the request of the digital media providing device 120. The program code can be automatically executed or can be initiated by a user. The user can also adjust relevant transcoding parameters. In further still another example embodiment, the transcoding device 140 comprises a display device. When the digital media providing device 120 is coupled to the transcoding device 140, messages or figures can be shown on the display device of the transcoding device 140 for assisting the user to perform transcoding related operation. For example, confirmation dialogs containing figures or messages can be shown. When the user activates or confirms the transcoding operation, e.g., click buttons or press keys, the transcoding operation can be performed. Furthermore, a password authentication and parameters adjusting dialog can also be adopted. The program code can be executed after the correct password is entered or the parameters are properly adjusted.

The functional blocks and the relative position of the devices and components in FIG. 1 are only illustrative. For example, the digital media providing device 120 can be implemented with an integrated device. The storage devices 122 and 124 can also be configured to be external components. Alternatively, the storage device 122 can also be configured in the transcoding device 140. When the digital media receiving devices 160 and 180 request the digital media providing device 120 to transmit the media data of the first and the second encoding formats, respectively, the digital media providing device 120 can access the storage 122 in the transcoding device 140 for providing the media data of the first encoding format. Besides, the digital media providing device 120 requests the transcoding device 140 to perform the transcoding operation for generating the media data of the second encoding format. The media data of the first and the second encoding formats are transmitted to the digital media receiving devices 160 and 180 by the transcoding device 140, respectively. Alternatively, the transcoding device 140 can transmit the media data of the first and the second encoding formats to the digital media providing device 120, and the digital media providing device 120 then transmits the media data of the first and the second encoding formats to the digital media receiving devices 160 and 180, respectively.

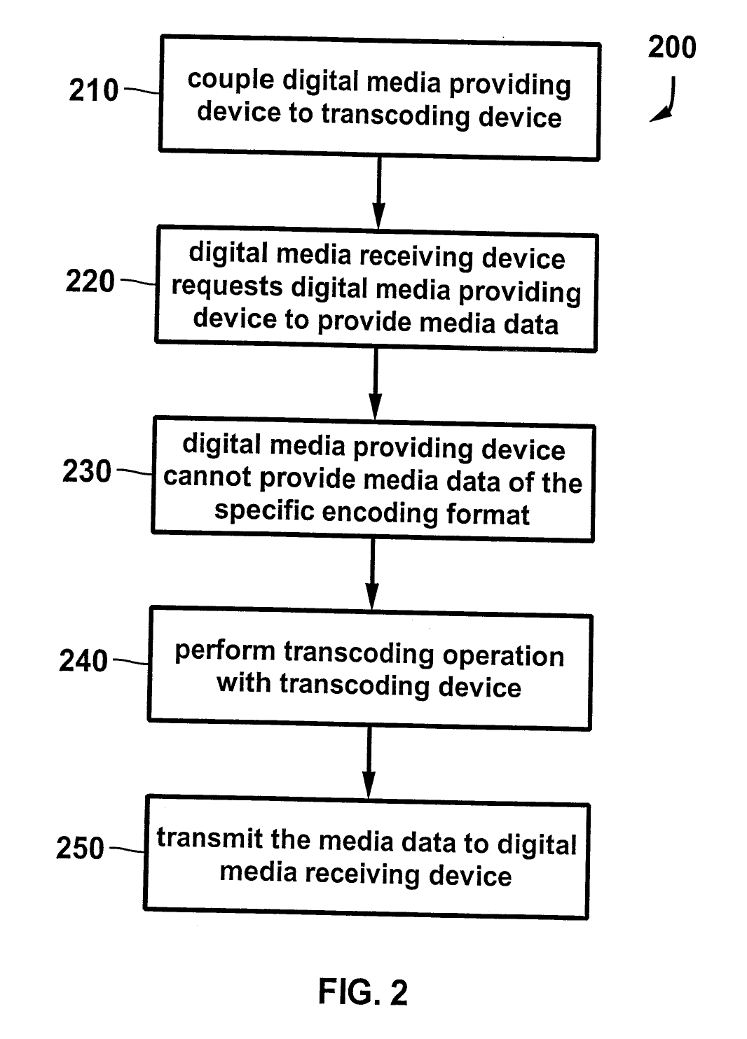

FIG. 2 shows a flowchart of an example transcoding method. In an operation 210, the digital media providing device 120 is coupled to the transcoding device 140. The transcoding device 140 executes the program code and waits for the transcoding requests of the digital media providing device 120. In an operation 220, the digital media receiving device 180 requests the digital media providing device 120 to provide the media data of the second encoding format. In an operation 230, the digital media providing device120 cannot perform the transcoding operation by itself and requests the transcoding device 140 to perform the transcoding operation. In an operation 240, the transcoding device 140 receives the media data from the digital media providing device 120, and converts the media data into the second encoding format. In an operation 250, the digital media providing device 120 or the transcoding device 140 transmit the media data of the second encoding format to the digital media receiving device 180.

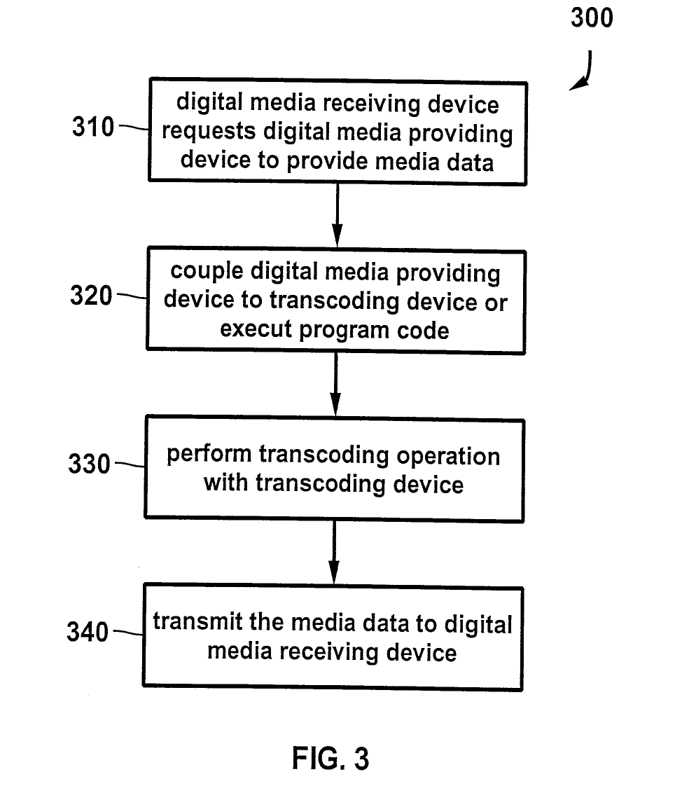

FIG. 3 shows a flowchart of another example transcoding method. In an operation 310, the digital media receiving device 180 requests the digital media providing device 120 to provide the media data of the second encoding format. In this moment, the digital media providing device 120 is not yet coupled to the transcoding device 140. Alternatively, the digital media providing device 120 is coupled to the transcoding device 140, but the transcoding device 140 has not yet executed the program code. In an operation 320, the digital media providing device120 cannot perform the transcoding operation by itself. The digital media providing device 120 starts coupling to the transcoding device 140 and request the transcoding device 140 to execute the program code and perform the transcoding operation. If the transcoding device 140 has already coupled to the digital media providing device 120 but not yet executed the program code, the digital media providing device 120 then instructs the transcoding device 140 to execute the program code and perform the transcoding operation. In an operation 330, the transcoding device 140 receives the media data from the digital media providing device 120, and converts the media data into the second encoding format. In an operation 340, the digital media providing device 120 or the transcoding device 140 transmit the media data of the second encoding format to the digital media receiving device 180.

The structures and methods shown in FIGS. 1-3 and mentioned above can be combined in any suitable manner. For example, in the operations 250 and 340, the media data of the second encoding formats can be transmitted to the digital media receiving devices 180 by the transcoding device 140, directly. Alternatively, the transcoding device 140 can transmit the media data of the second encoding formats to the digital media providing device 120, and the digital media providing device 120 then transmits the media data of the second encoding formats to the digital media receiving devices 180.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A digital media providing device comprising:
a first interface for coupling to a first storage device storing a first media data of a first encoding format;
a second interface for coupling to a second storage device storing a program code; and
a third interface for coupling to a transcoding device;
wherein the transcoding device executes the program code when the third interface is coupled to the transcoding device, converts the first media data in to a second media data of a second encoding format, and transmits the second media data to a digital content receiving device.

2. The digital media providing device of claim 1, wherein the transcoding device automatically executes the program code when the digital media providing device is coupled to the transcoding device.

3. The digital media providing device of claim 2, wherein the digital media providing device is recognized as a mass storage device when the digital media providing device is coupled to the transcoding device.

4. The digital media providing device of claim 2, wherein the transcoding device automatically executes the program code when a confirmation figure and/or message shown on a display of the transcoding device is activated.

5. A digital media providing device, comprising:
a first interface for coupling to a first storage device storing a first media data of a first encoding format;
a second interface for coupling to a second storage device storing a program code; and
a third interface for coupling to a transcoding device;
wherein the transcoding device executes the program code when the third interface is coupled to the transcoding device and converts the first media data in to a second media data of a second encoding format, the third interface receives the second media data from the transcoding devices, and the digital media providing device is coupled to a digital media receiving device through the third interface and/or a fourth interface for transmitting the second media data.

6. The digital media providing device of claim 5, wherein the transcoding device automatically executes the program code when the digital media providing device is coupled to the transcoding device.

7. The digital media providing device of claim 6, wherein the digital media providing device is recognized as a mass storage device and the transcoding device automatically executes the program code when the digital media providing device is coupled to the transcoding device.

8. The digital media providing device of claim 5, wherein the transcoding device automatically executes the program code when a confirmation figure and/or message shown on a display of the transcoding device is activated.

9. A computer program product capable of enabling a computer to perform a transcoding operation, the transcoding operation comprising:
receiving a first media data of a first encoding format from a digital media providing device; and
converting the first media data into a second media data of a second encoding format.

10. The computer program product of claim 9, the transcoding operation further comprising preloading the computer program product on the computer and detecting whether the digital media providing device is coupled to the computer.

11. The computer program product of claim 9, the transcoding operation further comprising transmitting the second media data to the digital media providing device.

12. The computer program product of claim 9, the transcoding operation further comprising:
receiving an address information of a digital media receiving device from the digital media providing device; and
transmitting the second media data to the digital media receiving device.
